(19) United States
(12) Patent Application Publication
(10) Pub. No.: US 2006/0282954 A1
(43) Pub. Date: Dec. 21, 2006

(54) Method to produce a mattress core and composed spring applied therewith

(76) Inventor: Willy Poppe, Sint-Niklaas (BE)

Correspondence Address: BACON & THOMAS, PLLC, 625 SLATERS LANE, FOURTH FLOOR, ALEXANDRIA, VA, 22314, US

(21) Appl. No.: 10/569,369

(22) PCT Filed: Aug. 20, 2004
(86) PCT No.: PCT/BE04/00119

§ 371 Date: Feb. 24, 2006

(30) Foreign Application Priority Data
Aug. 27, 2003 (BE) 2003/0466

(51) Int. Cl. B68G 7/00

(52) U.S. Cl. 5/720; 29/91.1

(57) ABSTRACT

Method for producing a mattress core with two flexible supports between which composed springs are installed, each consisting of a wire spring around which is applied a flexible tubular casing of foam. Wire springs are produced with various wire diameters and various outer diameters; foam cases are provided with various characteristics; the composed springs are formed with a desired rigidity by means of a suitable combination of wire springs and foam casings. Glue is applied to the ends of the composed springs and they are installed between the supports to form the mattress in accordance with a desired pattern.

The present invention concerns a method to produce a mattress core.

In particular, the invention aims a method to produce a mattress core of the type consisting of two flexible supports in between which successive rows of composed springs, analogous to those of the European patent no. 0.624.332, have been applied each consisting of a wire spring around which is applied a flexible tubular casing of foam, which casing is provided with radially directed cavities.

It is known that to produce such mattress cores a method is. applied whereby the composed springs are glued at their crosscut ends and provided with a finishing layer.

It is known that to produce such mattress cores in general a limited number of types of standard pre-formed springs are used as a basis, each with their specific characteristics regarding compressibility, which is obtained by the use of deviant wire diameters of the steel spring. These springs are applied according to a certain standard pattern in between the supports to create for example areas where the mattress cores is softer than in other areas.

A disadvantage of this method is that only a limited number of types of springs can be created, so that one can only in a limited way take advantage of the flexibility of the aforementioned areas to be able to adjust the lay comfort of the mattress core.

Another disadvantage is the large diameter of the composed springs used, which diameter is about 120 millimetre, due to which only a limited number of springs can be used in a mattress core and the load on each spring is very large.

Yet another disadvantage of this known method is that the mattress cores are produced according to a previously determined standard configuration, whereby the softer and more rigid areas are always located in the same locations in the mattress core and whereby, for example at the location of the pelvis, softer springs are being used.

A disadvantage connected therewith is the fact that such standard mattresses are not necessarily suitable for every user and that the lay comfort experienced by the user depends on the figure, the personal preference and the like.

The invention aims a method that will offer a solution for one or more of the above disadvantages.

To this end, the invention concerns a method to produce a mattress core of the aforementioned type, consisting of the production of wire springs with various diameters, whereby use is made of reels with spring wires which are being coiled to wire springs of various diameters; the forming of foam casings with various characteristics; the forming of composed springs with a desired rigidity by a suitable combination of the casing thus obtained with a wire spring; the application of glue on the crosscut ends of the composed springs; the application of the glued springs in between the aforementioned supports of the mattress core and this according to a desired pattern.

This method allows for the formation of mattress cores in a flexible way with various characteristics, whereby for each spring separately the desired rigidity may be imposed in order to be able to produce mattress cores which regarding lay comfort completely comply with the specific needs of each user.

To compose the composed springs preferably use is made of foam casings, the inner diameter of which, when not mounted, is smaller than the outer diameter of the wire springs concerned, this contrary to the known composed springs, as described in the EP 0.624.332, whereby foam casings are applied with an inner diameter equal to the outer diameter of the wire springs.

Because the inner diameter of the casing is smaller than the outer diameter of the wire spring, the casing is tightened around the wire spring, and the radially directed cavities of the foam casing are so to speak opened wide, as a result of which the rigidity of the composed springs can be adjusted more accurately than in the known applications whereby the casings are applied without stress over the wire springs.

Depending on the desired characteristics of a concerned composed spring, a foam casing is chosen according to the invention with a suitable inner diameter and thickness of the foam casing and with a suitable rigidity of the foam.

An advantage of this method for the composition of the springs is that in this way there will be an almost infinitely number of possibilities to change the rigidity of each composed spring of the mattress core by adjusting the inner diameter of the foam casing.

Another advantage is that the composed springs have a smaller inner diameter than the known composed springs with similar characteristics, due to which a larger number of springs can be applied in a mattress core resulting in yet more possibilities than in the past in order to be able to adjust the mattress core on the spot according to the desires of the user.

Yet another advantage is that in practice due to the tension exercised by the foam casing, use can be made of casings with a thinner wall than in the case of the known springs, so that a considerable saving of foam can be realised which may be more than 50% without fatigue tests showing considerable loss of rigidity or height.

Preferably, the method is executed according to an automated process whereby, so as to speak made to measure each user, based on a desired layout pattern for the springs imposed by said user and based on the imposed desired characteristics which may for example be determined by a computerised measurement system, for each of the said springs separately, the suitable wire springs and casings are made and combined with each other to obtain springs with the imposed desired characteristics and whereby the obtained springs, when composing the rows, are applied on the desired location in order to form the successive rows of springs with the desired composition and characteristics of the mattress core to be produced.

The invention also concerns a composed spring which can be applied in the method described above and which in general consists of a wire spring around which is applied a flexible tubular casing of foam, which casing is provided with radially directed cavities, whereby the inner diameter of the casing, when not mounted, is considerably smaller than the outer diameter of the wire spring.

In order to better explain the characteristics of the invention, a preferred embodiment of a method to produce a mattress core according to the invention is described as an example without being limitative in any way, as well as a preferred embodiment of a composed spring applied therewith, with reference to the accompanying drawings, in which:

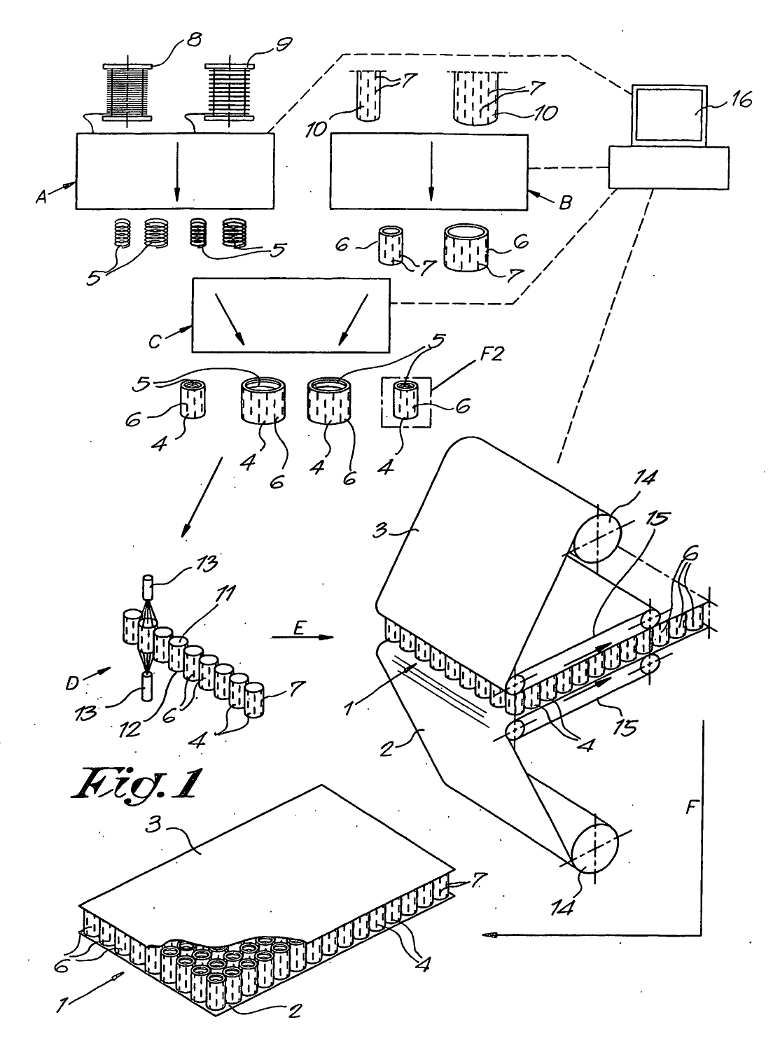

FIG. 1 is a schematic representation of the successive steps of a method according to the invention;

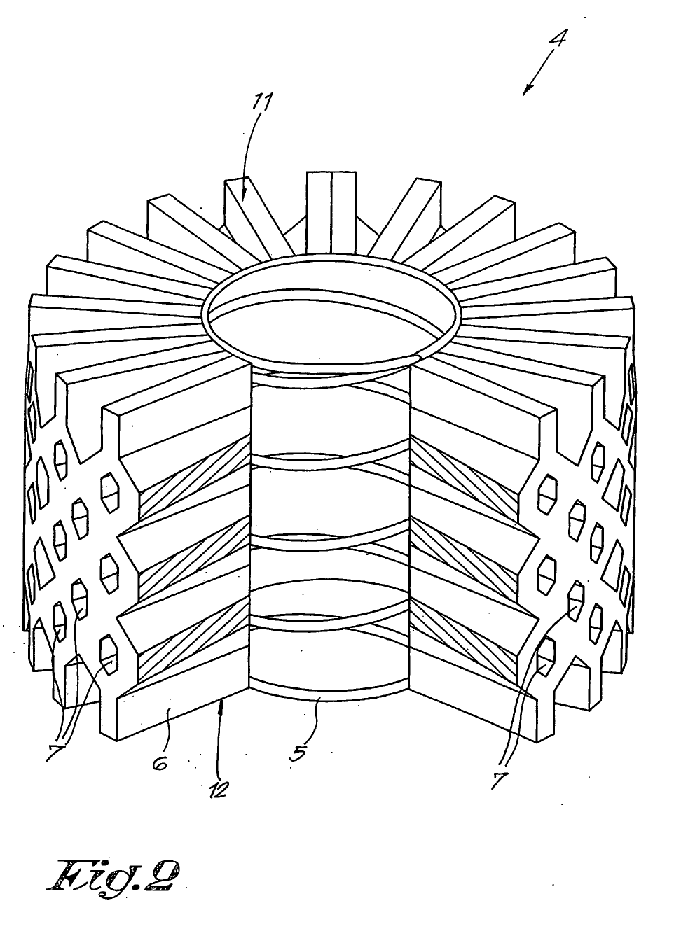

FIG. 2 is a representation on a larger scale of a part which is indicated in FIG. 1 as F2.

In FIG. 1 the successive steps are shown of a method according to the invention to produce a mattress core 1, which in general consists of two flexible supports 2 and 3 in between which a number of rows of composed springs 4 are applied which as shown in FIG. 2, each consist of a wire spring 5 around which a flexible tubular casing 6 of foam is applied, which casing 6 is provided with radially directed cavities 7.

The mattress core 1 is produced based on a number of data which are for example stored in a central controlling computer 16 or the like and which contains for each mattress core 1 to be produced the data concerning the desired layout pattern of the composed springs 4 in between the supports 2-3 and of the desired specific characteristics of each composed spring 4 separately, and this in function of the wishes and needs of the user concerned.

Said data can for example be obtained by a measuring arrangement, not shown in the figures, whereby use is made of a test arrangement with a mattress core onto which a test person can take place and which is provided with a number of springs, the rigidity of which can be set and measured, for example by means of compressed air or the like, in order to realise the most optimal lay comfort for the test person.

Based on the measurement results obtained, composed springs. 4 are then automatically made with the desired characteristics and in the desired order.

To this end wire springs 5 are first produced in step A based on a number of reels 8, which reels are each provided with a spring wire 9 with a different diameter of for example 2 millimetre, 2.2 millimetre or the like, whereby the spring wire 9 is coiled by a suitable winding head to a wire spring 5 with a suitable diameter.

At the same time a corresponding casing 6 is produced in step B for each wire spring 5 based on hoses 10 in foam which are provided with radially directed cavities 7 and the casings 6 of which are cut at a suitable length.

The hoses 10 used as a basis, are for example applied to reels not shown in the figures, and have different characteristics which are among others determined by the thickness of the foam casing 6, for example fifteen and twenty millimetre, by the specific gravity of the foam casing, for example 45 or 55 kg/m³ or the like, and especially by the sizes of the foam casing, more particular its inner diameter.

The aforementioned wire springs 5 and foam casings 6 thus obtained, are combined in the next step C into composed springs 4 which comply with the requirements indicated in the computer 16 and the said composed springs are then collected together row by row according to the desired lay-out pattern.

Preferably, for the composition of the springs 4 casings 6 are chosen, the inner diameter of which is, when the casing is not mounted, considerably smaller than the outer diameter of the wire spring 5 concerned, so that the casing 6 interacts with the wire spring 5 with a certain tension.

Consequently, during a step D the crosscut sides of the ends 11-12 are provided with a layer of glue by means of a glue pistol 13 or the like and in a following step E the glued composed springs 4 are applied row by row in between the supports 2-3 and glued in between these supports, whereby the supports 2-3 are to this end for example each unrolled from a roll 14 and guided together with the composed springs 4 in between two conveyers 15 which are placed opposite of each other.

Once the complete mattress core 1 is composed according to the pattern indicated in the computer 16, the supports 2 and 3 are cut in a step F to the suitable length in order to obtain the finished mattress core 1 which may further be used as a basis for a mattress with the required characteristics in function of the data of the user concerned.

It is obvious that the central computer 16 can be used to control the consequent steps A through F of the method according to the invention in a suitable manner, whereby it is possible to produce mattress cores 1 in an efficient and flexible way on an individual basis and according to a continuous process, so to speak made to measure according to previously set data regarding the requirements of the users.

It is obvious that the number of types wire springs 5 to be produced is relatively limited, but that each type of wire spring 4 may be combined with an unlimited number of types of casings 6, which are chosen automatically by the computer in function of the previously entered scheme.

Although in the example shown for the formation of the casings 6, direct use is already made of hoses 10 are from which are delivered on reels, it is not to be excluded that the casings 6 are made piece by piece using flat strips of foam which are perforated or provided with notches to form the cavities 7 and which are folded into a tubular element, whereby the edges of the strip which are applied opposite each other, are glued together.

The present invention is in no way limited to the method described as an example and shown in the figures and to the composed spring applied therewith, but a method according to the invention and a spring applied therewith can be realised according to all kinds of other alternatives without departing from the scope of the invention.

1. Method for producing a mattress core having two flexible supports in between which successive rows of composed springs are applied, each comprising a wire spring around which is applied a flexible tubular casing of foam, which casing is provided with radially directed cavities, comprising the steps: providing wire springs with various wire diameters using spring wire, supplied from reels of spring wires which are coiled into wire springs with various outer diameters; forming foam casings with various characteristics; preparing composed springs each with a desired rigidity by selecting a suitable combination of a foam casing and a selected one of said formed wire springs applying of glue to the ends of the composed springs and installing the composed springs with glue in between the supports of a mattress core according to a desired pattern.

2. Method according to claim 1, including using foam casings having inner diameters smaller than the outer diameters of the wire springs before the casings are assembled to the wire springs.

3. Method according to claim 2, wherein for obtaining the desired characteristics of a composed spring a foam casing is selected having a selected inner diameter and thickness, and a selected rigidity.

4. Method according to claim 1, comprising using an automated process including using an imposed desired lay-out pattern of the composed springs and with the use of imposed desired characteristics for each of these springs separately, the suitable wire springs and casings are made and combined with each other to obtain composed springs with the desired imposed characteristics and installing obtained springs according to a desired pattern in between the supports in order to thus form a mattress core with the desired lay-out and characteristics of the mattress core to be produced.

5. Method according to claim 1, wherein the casings are formed using foam hoses with various characteristics which are provided with radially directed cavities and from which casings having a suitable length are cut.

6. Method according to claim 1, wherein the casings are produced using flat strips of foam with various characteristics, and wherein notches are provided in the strips to form the cavities, and wherein the strips are folded into a tube and the ends of the strips are joined together and connected to each other.

7. Composed spring for use in the method according to claim 1, comprising a wire spring having an outer diameter, around which is applied a flexible tubular casing of foam, said casing having an inner diameter. which casing is provided with radially directed cavities, and wherein characterised in that the inner diameter of the casing, when the casing is not mounted to a wire sring, is considerably smaller than an outer diameter of the wire spring.
